(19) United States
(12) Patent Application Publication
(10) Pub. No.: US 2019/0234421 A1
(43) Pub. Date: Aug. 1, 2019

(54) EDGE FORMATION FOR FAN BLADE OF HVAC SYSTEM

(71) Applicant: Johnson Controls Technology Company, Auburn Hills, MI (US)

(72) Inventors: Stephen C. Wilson, Oklahoma City, OK (US); John T. Knight, Moore, OK (US)

(21) Appl. No.: 15/925,541

(22) Filed: Mar. 19, 2018

Related U.S. Application Data
(60) Provisional application No. 62/623,380, filed on Jan. 29, 2018.

(51) Int. Cl. F04D 29/38; F24F 11/74; F04D 29/66

(52) U.S. Cl. CPC F04D 29/388; F05D 2240/304; F04D 29/667; F24F 11/74

(57) ABSTRACT

A fan blade includes an edge formation disposed on an edge of the fan blade, where the edge formation comprises an incline surface relative to a main portion of the fan blade and a decline surface relative to the main portion of the fan blade, and wherein the incline surface and the decline surface are asymmetric to one another.

### CROSS-REFERENCE TO RELATED APPLICATION

This application is a Non-Provisional application claiming priority to U.S. Provisional Application No. 62/623,380, entitled “EDGE FORMATION FOR FAN BLADE OF HVAC SYSTEM,” filed Jan. 29, 2018, which is hereby incorporated by reference in its entirety for all purposes.

### BACKGROUND

The present disclosure relates generally to heating, ventilating, and air conditioning (HVAC) systems, and specifically, to edge formations for fan blades of fans in an HVAC systems.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Environmental control systems are utilized in residential, commercial, and industrial environments to control environmental properties, such as temperature and humidity, for occupants of the respective environments. The environmental control system may control the environmental properties through control of an air flow delivered to and ventilated from the environment. For example, a heating, ventilating, and air conditioning (HVAC) system may use fans to direct and circulate airflow within the HVAC system. In addition, the HVAC system may use fans in conjunction with heat exchangers to change the temperature of the air.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

In one embodiment, a fan blade includes an edge formation disposed on an edge of the fan blade, where the edge formation comprises an incline surface relative to a main portion of the fan blade and a decline surface relative to the main portion of the fan blade, and where the incline surface and the decline surface are asymmetric to one another.

In one embodiment, an end cap for a fan blade includes an edge formation disposed on a side of the end cap. The edge formation includes an incline surface relative to the side of the end cap and a decline surface relative to the side of the end cap, where the incline surface and the decline surface are asymmetric relative to one another.

In one embodiment, a fan blade includes a first set of edge formations disposed on a first edge of the fan blade and a second set of edge formations disposed on a second edge of the fan blade. Each edge formation of the first set of edge formations includes a first incline surface relative to a main portion of the fan blade and a first decline surface relative to the main portion of the fan blade, where the first incline surface and the first decline surface are asymmetric to one another. Each edge formation of the second set of edge formations includes a second incline surface relative to the main portion of the fan blade and a second decline surface relative to the main portion of the fan blade.

### DRAWINGS

Various aspects of this disclosure may be better understood upon reading the following detailed description and upon reference to the drawings in which:

FIG. 1 is a schematic of an environmental control for building environmental management that may employ one or more HVAC units, in accordance with an aspect of the present disclosure;

FIG. 2 is a perspective view of an embodiment of an HVAC unit that may be used in the environmental control system of FIG. 1, in accordance with an aspect of the present disclosure;

FIG. 3 is a schematic of a residential heating and cooling system, in accordance with an aspect of the present disclosure;

FIG. 4 is a schematic of an embodiment of a vapor compression system that can be used in any of the systems of FIGS. 1-3, in accordance with an aspect of the present disclosure;

FIG. 5 is a top view of an embodiment of a fan that may be used in any of the systems of FIGS. 1-4, in accordance with an aspect of the present disclosure;

FIG. 6 is a perspective view of a section of an embodiment of a fan blade that may be used in any of the systems of FIGS. 1-4, in accordance with an aspect of the present disclosure;

FIG. 7 is a perspective view of a section of an embodiment of a fan blade that may be used in any of the systems of FIGS. 1-4, in accordance with an aspect of the present disclosure;

FIG. 8 is a front view of an embodiment of a profile that may be formed in the fan blade of FIG. 5 or FIG. 6, in accordance with an aspect of the present disclosure;

FIG. 9 is a perspective view of an embodiment of an end cap that may be coupled to a fan blade, in accordance with an aspect of the present disclosure;

FIG. 10 is a perspective view of an embodiment of an end cap that may be coupled to a fan blade, in accordance with an aspect of the present disclosure;

FIG. 11 is a top view of an embodiment of an end cap that may be coupled to a fan blade, in accordance with an aspect of the present disclosure;

FIG. 12 is a bottom view of an embodiment of an end cap that may be coupled to a fan blade, in accordance with an aspect of the present disclosure; and

FIG. 13 is a perspective view of an embodiment of an end cap that may be coupled to a fan blade, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to heating, ventilating, and air conditioning (HVAC) systems that use fans. For example, fans may be used to circulate air that flows through the HVAC system, such as to expel air out of the HVAC system. In addition, the fans may be used with heat exchangers that exchange heat between the air in the HVAC system and a refrigerant within tubes or coils of the heat exchangers. For example, the fan may blow air across the heat exchanger to transfer heat to or from a refrigerant flowing through tubes or coils of the heat exchanger. In some embodiments, the fans may use blades, such as propeller fan blades, that rotate during operation. The fan blades may be formed in a certain geometry to efficiently transport air. However, during rotation of the fan blade, the fan blade's geometry may induce movement of the air that generates noise.

Thus, in accordance with certain embodiments of the present disclosure, it is presently recognized that modifying fan blades may reduce noise of the fans during operation. For example, an edge of the fan blade, such as the leading or trailing edge, may be manufactured to have a geometry to disrupt the flow of air across the edge of the blade to decrease the noise. Likewise, present embodiments include caps, such as fan end caps, having edge formations or features that may slide onto existing fan blades to reduce noise during operation of the fan. By reducing noise, the end caps enable the fan to operate at a higher efficiency. For example, the fan may operate at a higher efficiency because less fan power is lost or wasted on generating noise. As such, the fan may utilize a higher output power, relative to a fan operating without the end caps, while limiting noise generated by the fan. The end caps may be manufactured to accommodate the fan blade geometry and may be coupled to the fan blade.

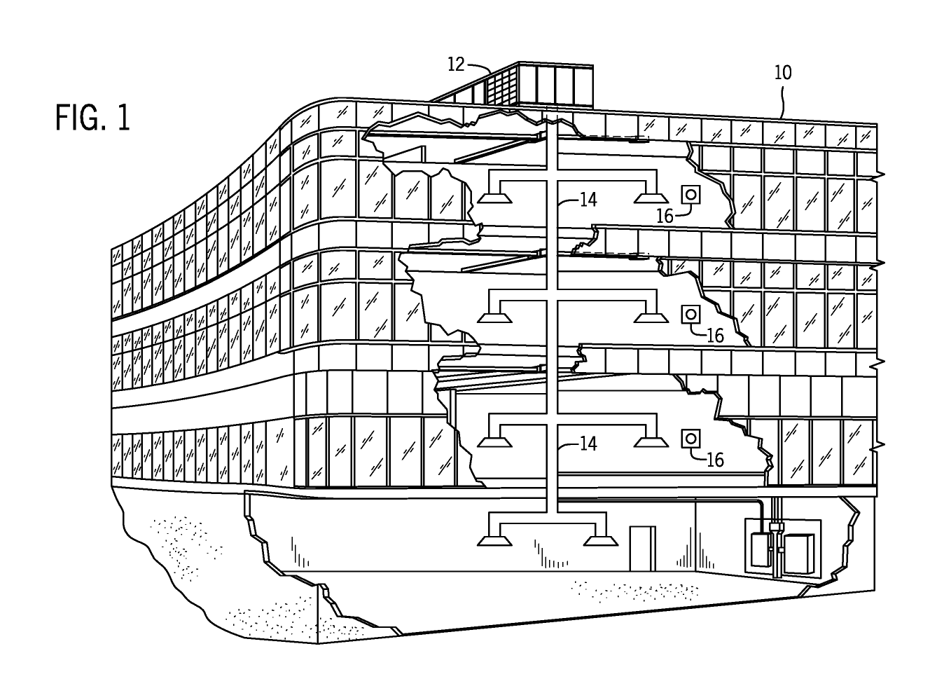

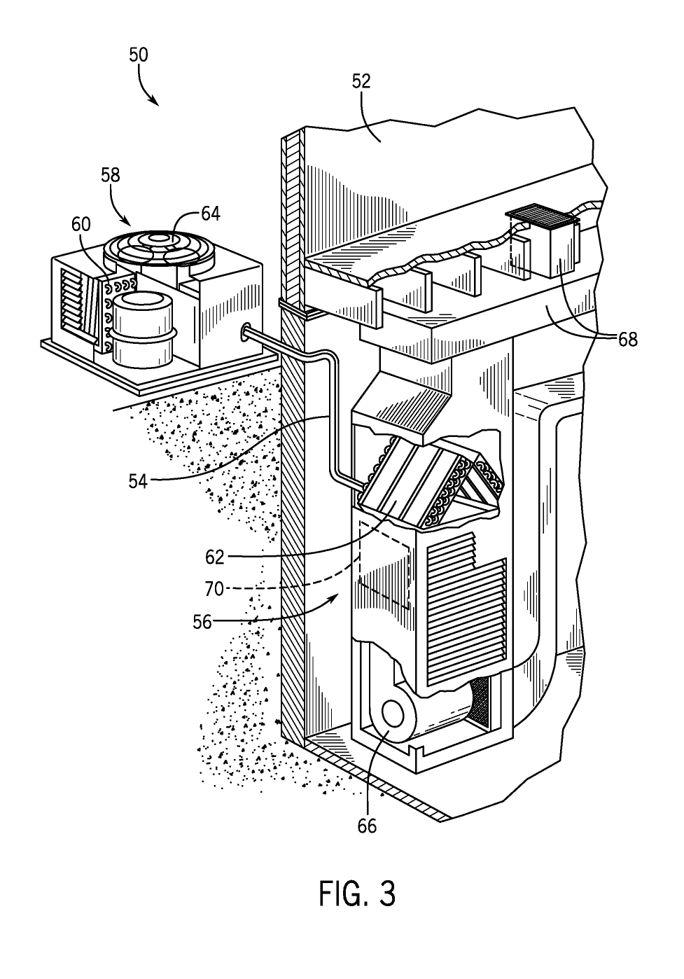

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single packaged unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream. In other embodiments, the HVAC unit 12 may include one or more refrigeration circuits for cooling an air stream and a reheat coil for heating and controlling the humidity in the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

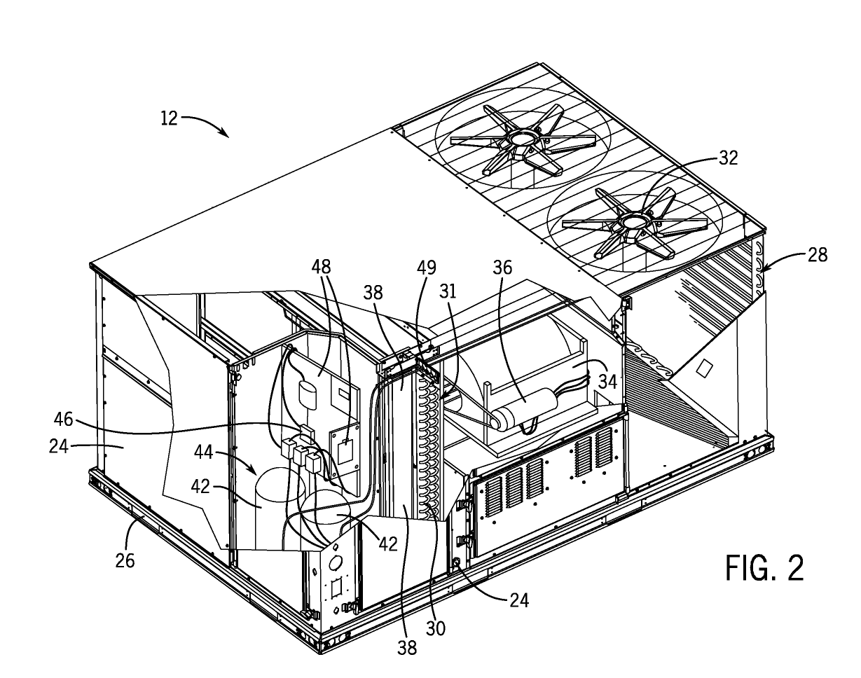

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, cooling with a heat pump, or cooling with reheat. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, reciprocating compressors, or modulating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over the outdoor heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

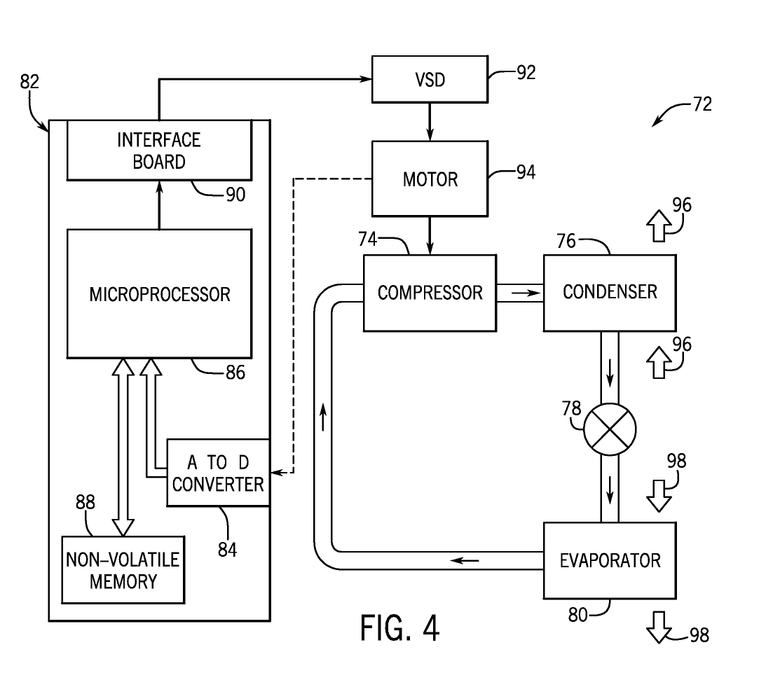

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 38 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As mentioned above HVAC systems may use fans, such as the fans 32 in FIG. 2, the fan 64 in FIG. 3, or another fan that includes fan blades. The fans may direct or circulate air flowing through the HVAC system and/or the fans may be used to facilitate heat transfer in a heat exchanger. The fans may contain several blades that rotate during operation of the fans. The fan blades may be manufactured at a particular geometry and pitch, but may generally contain a smooth profile. Rotation of the fan blades induces movement of air, such that air flows through the fan. However, the flow of air across an edge of a fan blade may induce noise and/or vibrations. In accordance with present embodiments, modifying the blade such that the blades no longer contain a smooth profile may disrupt the flow of the air to decrease the noise. For example, during manufacturing of the fan blade, an edge of the fan blade may be modified with tooling to contain an uneven profile rather than a smooth edge. In an existing or already-manufactured fan blade, an end cap may slide onto an edge of the fan blade to create the uneven profile for the edge of the blade. In either circumstance, the uneven profile may disrupt the flow of air across that edge of the blade to decrease the noise of operating the fan.

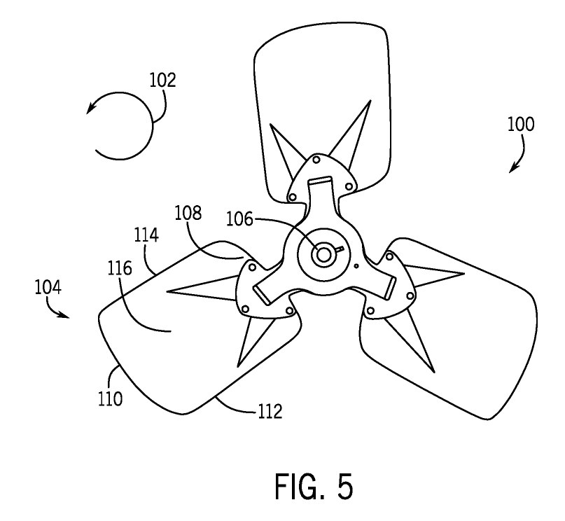

FIG. 5 is a top view of an embodiment of a fan 100, such as the fans 32 or the fan 64 discussed above, which may be used in an HVAC system. In some embodiments, the fan 100 may rotate in a direction 102 to circulate air through the HVAC system. The fan 100 may include several fan blades 104 that are each coupled to a hub 106 at a proximal edge 108 of each fan blade 104. The hub 106 may rotate, thereby rotating the fan blades 104. Each fan blade 104 may further include a distal edge 110 that is furthest away from the proximal edge 108, a leading edge 112 that is the front of the fan blade 104 during rotation of the fan 100 in the direction 102, and a trailing edge 114 that is the back of the fan blade 104 during rotation of the fan 100 in the direction 102. Each fan blade 104 may also include a main portion 116 that is the section at the center of the fan blade 104 in between the proximal edge 108, the distal edge 110, the leading edge 112, and the trailing edge 114. The main portion 116 includes a suction surface and a pressure surface. In some embodiments, rotation of the fan 100 may produce noise caused by the movement of air at and edge, such as the trailing edge 114, after flowing across the suction surface and the pressure surface of the fan blade 104.

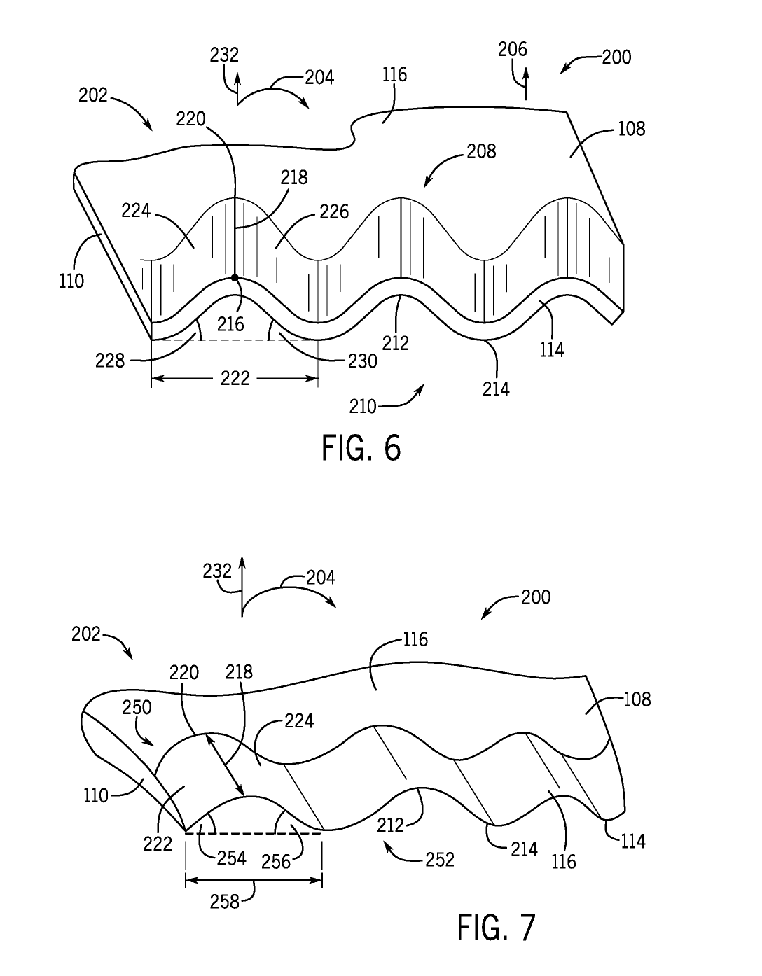

FIG. 6 illustrates an embodiment of a section of a fan blade 200 that may reduce noise caused by rotation of a fan. The fan blade 200 includes the proximal edge 108, the distal edge 110, the trailing edge 114, and the main portion 116 described above. The main portion 116 may further include a surface 202, such as a suction surface. The fan blade 200 may rotate in a direction 204 about an axis 206 that is crosswise to the surface 202. The fan blade 200 may include a plurality of edge formations 208 integrally formed with the fan blade 200 that form a profile 210 along the trailing edge 114. As such, the profile 210 forms a geometry along the trailing edge 114 crosswise to the surface 202 of the main portion 116. The edge formations 208 may be positioned or formed such that the main portion 116 does not include the edge formations 208. As an example, the profile 210 may include peaks 212 and valleys 214, which change the elevation of the edge formation 208 from the surface 202 up to the trailing edge 114. In some embodiments, the peaks 212 and valleys 214 may be curved shapes that are of substantially the same geometry. Although FIG. 5 illustrates a certain number of edge formations 208, in other embodiments, a different number of edge formations 208 may be formed in the fan blade 200, such as a different number of peaks 212 and/or valleys 214.

Each edge formation 208 includes a vertex 216 that is an extremum of each respective peak 212 or valley 214. That is, the vertex 216 is the highest point in a peak 212 or the lowest point in a valley 214. Further, each edge formation 208 includes a vertex line 218 that is a line that connects extrema along each edge formation 208. The vertex line 218 may connect the vertex 216 proximate to the trailing edge 114 to a point 220 that couples the edge formation 208 with the main portion 116. A width 222 of the edge formation 208 may expand along the vertex line 218 from the point 220 to the profile 210. As such, each edge formation 208 may be a generally conical shape. The vertex line 218 may divide each edge formation 208 into an incline surface 224 and a decline surface 226. For example, in an edge formation 208 on the surface 202, the incline surface 224 may be a surface of the edge formation 208 that leads up to the vertex line 218 and includes a departure angle 228 with respect to the main portion 116. Likewise, the decline surface 226 may be a surface of the edge formation 208 after the vertex line 218 and includes an approach angle 230 with respect to the main portion 116. In some embodiments, the edge formation 208 may be asymmetrical about the vertex line 218, such that the incline surface 224 is asymmetrical with respect to the decline surface 226. Furthermore, as shown in FIG. 6, the vertex line 218 may be coaxial to a direction 232 that is substantially tangential to the direction 204 or the direction of rotation of the fan blade 200.

In other embodiments of the fan blade 200, the geometry of the edge formations 208 may be different compared with that of the embodiment of the fan blade 200 in FIG. 6. For example, FIG. 7 illustrates another embodiment of a section of the fan blade 200 that includes edge formations 250 that are different than the edge formations 208 of FIG. 6. In some embodiments, the edge formations 250 form a profile 252 that is different than the profile 210 of FIG. 6. As an example, a departure angle 254 and an approach angle 256 may each be less than the respective departure angle 228 and the approach angle 230 of FIG. 6, and a width 258 may be different than the width 222. The edge formations 250 may further be angled with respect to the direction 232. That is, each respective point 220 coupling the edge formations 250 with the main portion 116 may be positioned such that the vertex line 218 is angled relative to the direction 230. As such, the edge formations 250 may be angled compared to the edge formations 208.

The edge formations 208 and the edge formations 250 may each disrupt the flow of air across the fan blade 200. For example, as the fan blade 200 rotates, air may travel from the leading edge 112 through the main portion 116 across the fan blade 200 to the trailing edge 114. Proximate to the leading edge 112, the air may smoothly flow across the fan blade 200. Before the air reaches the trailing edge 114, the air may encounter the peaks 212 and the valleys 214 that disrupt the smooth flow of the air, which otherwise may generate noise. For example, the air may separate to flow at different directions, such as along the peaks 212 and along the valleys 214 to flow at different heights. The separation of airflow may reduce noise generated by rotating the fan blade 200.

The different geometries of the edge formations 208 and 250 may disrupt the flow of air in different manners. For example, the edge formations 250 may disrupt the flow of the air to travel at a different angle relative to the disruption of the flow of the air caused by the edge formations 208 in FIG. 6. However, the disruption in flow may still keep the air from producing noise during rotation of the fan blade 200.

In some embodiments, the fan blade 200 may not include the edge formations 208 or 250 at the distal edge 110 and/or the leading edge 112. In other embodiments, the distal edge 110 and/or the leading edge 112 may include the edge formations 208, and/or multiple edges of the fan blade 200 may include the edge formations 208. Additionally, the edge formations 208 within each edge may include different geometries from one another. As an example, the profile 210 and/or the profile 252 may include peaks 212 of different heights and/or valleys 214 of different heights within the profile 210 and/or the profile 252. In additional embodiments, the location of the points 218 may differ such that a length of each respective vertex line 218 may differ from one another. These changes in geometry may depend on fan blade pitch, rotation speed, material, application, desired longevity, method of forming, or any combination thereof. In other words, the particular geometry of the edge formations 208 and/or 250, such as the angles discussed above, the heights of the peaks and valleys discussed above, and so forth, may be selected depending on design factors, such as fan blade pitch, fan blade rotation speed, air speed, and so forth.

To enable forming of the edge formations 208 on the blade 200, the blade 200 may include a malleable or flexible material, such as a metal, polymer, plastic, another suitable material, or any combination thereof. Additionally, forming the edge formations 208 may be via methods such as pressing, drilling, bending, another suitable method, or any combination thereof.

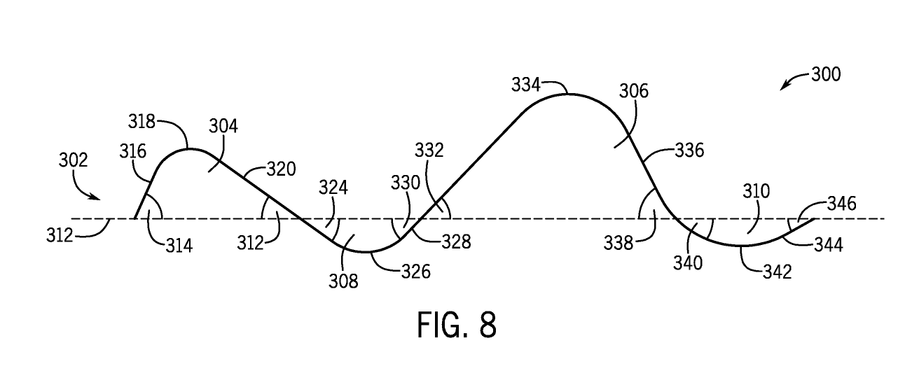

To further illustrate the geometry of different profiles and edge formations 208, FIG. 8 is a front view of a profile 300 that may be formed on an edge of a fan blade 200, such as the leading edge 112, trailing edge 114, or distal edge 110. As illustrated in FIG. 8, the profile 300 includes four edge formations 302, including a first peak 304, a second peak 306, a first valley 308, and a second valley 310. Additionally, the profile 300 illustrates baseline 312, which is a line that represents a general centerline, such as a camber line, between an upper and a lower surface of the main portion 116 of the fan blade 200. The edge formations 302 may include different departure angles and approach angles. For example, the first peak 304 may include a first departure angle 314 relative to the baseline 312 formed by a first incline 316 of the first peak 304. The first incline 316 of the first peak 304 may reach a first crest 318, which may be the highest point of the first peak 304. Beyond the first crest 318, there may be a first decline 320 that returns the first peak 304 to the baseline 312 to form a first approach angle 322 relative to the baseline 312. As illustrated in FIG. 7, the first departure angle 314 and the first approach angle 322 may include different angle measurements from one another, such as the first departure angle 314 being larger than the first approach angle 322. In this manner, the first incline 316 may be steeper than the first decline 320 relative to the baseline 312.

The first decline 320 may extend through the baseline 312 to form a second departure angle 324 relative to the baseline 312. In some embodiments, the second departure angle 324 may be substantially equal to the first approach angle 322. The first decline 320 may extend down to a first trough 326 to form the lowest point of the first valley 308. The first valley 308 may then return to the baseline 312 with a second incline 328, forming a second approach angle 330 about the baseline 312. As shown in FIG. 7, the second approach angle 330 may be substantially the same as the first approach angle 322 and the second departure angle 324, but in alternative embodiments, the second approach angle 330 may be different than the first approach angle 322 and the second departure angle 324.

The second incline 328 may then extend beyond the baseline 312 to form a third departure angle 332 relative to the baseline 312. In some embodiments, the third departure angle 332 may be substantially the same as the second approach angle 330 and thus the first approach angle 322 and the second departure angle 324. However, in other embodiments, the third departure angle 332 may be different than any of the other angles. The second incline 328 may reach a second crest 334 that is the highest point of the second peak 306. As illustrated in FIG. 7, the second crest 334 may be higher than the first crest 318. In other embodiments, the second crest 334 may be lower or substantially level with the first crest 318. Beyond the second crest 334, a second decline 336 returns the second crest 334 to the baseline 312, forming a third approach angle 338 relative to the baseline 312. The third approach angle 338 may be different or substantially the same compared to any of the previously mentioned angles.

The second decline 336 may extend beyond the baseline 312 to form a fourth departure angle 340 of the second valley 310. As illustrated in FIG. 8, the fourth departure angle 340 may be at a different angle than the third approach angle 338, despite sharing the same second decline 336. The second decline 336 may reach a second trough 342 to form the lowest point of the second valley 310. FIG. 8 illustrates the second trough 342 as offset from the first trough 326 but in other embodiments, the second trough 342 may be substantially level with the first trough 326. The second valley 310 may then return to the baseline 312 with a third incline 344 and form a fourth approach angle 346 relative to the baseline 312. The fourth approach angle 346 may be substantially the same as any of the other angles, such as the fourth departure angle 340, or the fourth approach angle 346 may be different than any of the other angles.

Although profile 300 includes four edge formations 302, different profiles may include any other number of edge formations 302. Furthermore, other profiles may include departure and approach angles of different measurements, peaks and valleys of different sizes and geometries, and inclines and declines of different lengths. The design of the profile may be configured according to factors such as fan blade pitch, rotation speed, material, application, desired longevity, method of forming, other design considerations of an HVAC system, or any combination thereof.

In addition to forming profiles directly onto a fan blade 200, profiles may be formed on a separate component that may couple to the fan blade 200. FIG. 9 is a perspective view of an embodiment of an end cap 400 that is configured to couple to an edge, such as the trailing edge 114, of the fan blade 200. By way of example, the end cap 400 may include a first side 402 and a second side 404 that are separated from one another by a slit 406. The slit 406 may extend along a length 408 of the end cap 400 from a third side 410 to a fourth side 412. The slit 406 may also extend along a height 414 of the end cap 400 from a fifth side 416 towards a sixth side 418. The slit 406 may end before reaching the sixth side 418 to create a stop 420. As such, the fan blade may slide through the fifth side 416 of the end cap 400 until the edge of the fan blade reaches the stop 420. During operation of the fan blade 200, the end cap 400 may rotate along with the rotation of the fan blade 200. As such, the end cap 400 may be coupled to the fan blade 200 to secure the end cap 400 onto the fan blade 200 during rotation of the fan blade 200. The end cap 400 may be coupled to the fan blade 200 via adhesives, fasteners, welds, pressing, another suitable method, or any combination thereof.

On the first side 402 and/or the second side 404, there may be edge formations 422 that form an uneven profile to disrupt the flow of air as the fan blade 200 rotates. The edge formations 422 may be formed to have similar geometries or profiles as the edge formations 208 of FIG. 5 and/or the edge formations 250 of FIG. 6. For example, each edge formation 422 may include a point 424 proximate to the fifth side 416. The edge formation 422 may extend from the point 424 to the sixth side 418, with a width 426 of the edge formation 422 expanding from the point 424 to the sixth side 418 to form a base 428, where the edge formation 422 meets the sixth side 418. The base 428 may be substantially level with the sixth side 418 such that the end cap 400 is substantially flat at the sixth side 418. The base 428 includes a vertex 430 that is an extremum of the base 428. The extension of the edge formation 422 from the point 424 to the sixth side 418 may be in a direction 432 that is substantially along the height 414. That is, a vertex line 434 that connects extrema along each edge formation 422 may extend from the point 424 to the vertex 430 substantially in the direction 432. The vertex line 434 may thus divide the edge formation 422 into an incline surface 436 that extends from the first side 402 up to the vertex line 434 and a decline surface 438 that extends from the vertex line 434 to the first side 402. In some embodiments, the edge formation 422 may be symmetrical about the vertex line 434 such that the incline surface 436 and the decline surface 438 are symmetrical, but in alternative embodiments, the edge formation 422 may be asymmetrical about the vertex line 434 such that the incline surface 436 and the decline surface 438 are asymmetrical. Furthermore, a surface of the edge formation 422 may be curved such that the shape of the edge formation 422 is conical.

For a fan blade that uses the end cap 400 at a trailing edge, during operation, the fan blade, and thus the end cap 400, may rotate along a direction 440. The fan blade may include edges that may not use the end cap 400 and the fan blade may include smooth surfaces. As such, air may smoothly flow across the fan blade but the flow may be disrupted when the air moves across the end cap 400 by encountering the edge formations 422. The disruption of the flow of air may reduce noise caused by the air. In some embodiments, the end cap 400 may also be configured to couple to a different edge of the fan blade, such as a leading edge or a distal edge. In such embodiments, the alignment of the edge formations 422 may be adjusted, such as flipping the edge formations 422 such that the respective points 424 are proximate to the sixth side 418 rather than the fifth side 416. In this manner, rotation of the fan blade may still disrupt the flow of air to reduce noise because the flow of air across the uneven profile created by the edge formations 422 keeps the air from flowing smoothly. Thus, the end cap 400 may be placed at any edge of the fan blade.

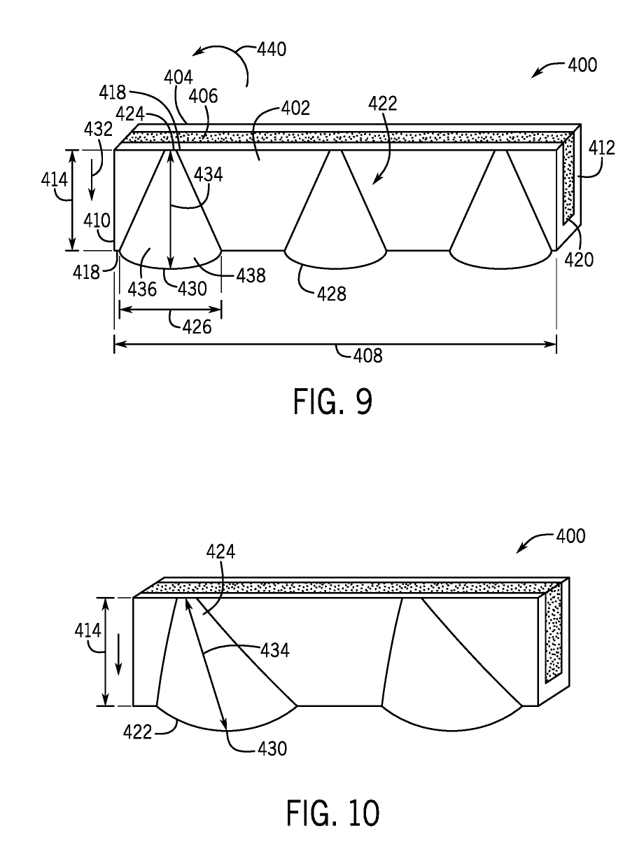

Another embodiment of the end cap 400 is illustrated in FIG. 10. This embodiment may include edge formations 422 that are angled as compared to the edge formations 422 of FIG. 8. That is, the vertex line 434 extending from the point 424 to the vertex 430 may be at an angle relative to the height 414 of the end cap 400. However, when this embodiment of the end cap 400 is coupled to a fan blade and the fan blade is in operation, the edge formations 422 may still disrupt the flow of air in a manner similar to the embodiment of the end cap 400 of FIG. 9.

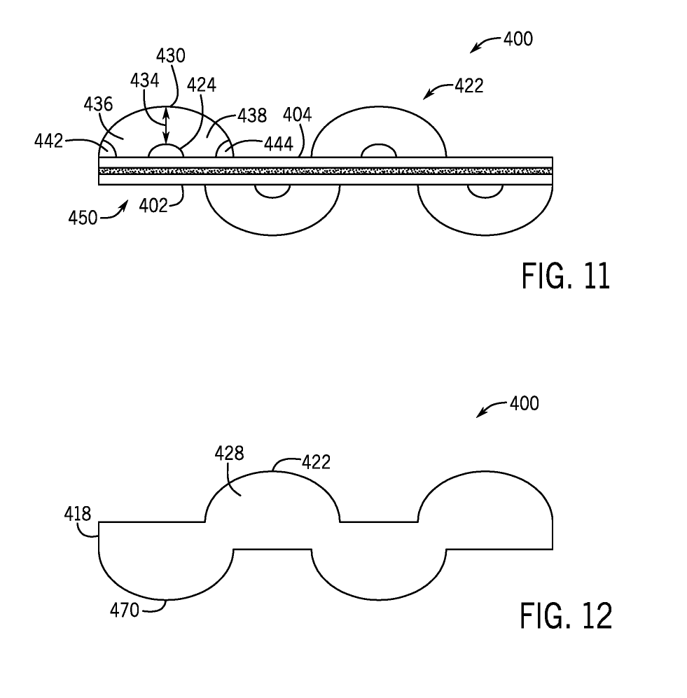

To further illustrate a frontal area which the flow of air may encounter when flowing over the end cap 400, FIG. 11 is a top view of an embodiment of the end cap 400. As shown in FIG. 11, the edge formations 422 of the first side 402 and the edge formations 422 of the second side 404 in conjunction may form a profile 450 that is generally sinusoidal in shape. The incline surface 436 forms a departure angle 442 relative to the second side 404 and the decline surface 438 forms an approach angle 444 relative to the second side 404. The departure angle 442 may be greater than, less than, or substantially the same as the approach angle 444. An edge formation 422 of similar geometry may also be placed at the second side 404.

Although FIG. 11 illustrates that the edge formations 422 of the first side 402 are offset from the edge formations 422 of the second side 404, in other embodiments, the edge formations 422 of the first side 402 may be substantially directly opposite to the edge formations 422 of the second side 302. Regardless of the positioning of the edge formations 422, the profile 450 created by the edge formations 422 may disrupt the flow of air across the end cap 400. When the end cap 400 is coupled to a rotating fan blade, the first side 402 may be proximate to a pressure surface of the fan blade and the second side 404 may be proximate to a suction surface of the fan blade. Thus, the first side 402 may be a pressure side and the second side 404 may be a suction side. During rotation, the flow of air across the pressure surface and/or the suction surface may be disrupted by the profile 450, thus reducing noise of the fan blade operation.

FIG. 12 is a bottom view of the embodiment of the end cap 400. As illustrated in FIG. 12, the base 428 of the edge formations 422 are substantially level with the sixth side 418, creating a substantially flat side. However, in alternate embodiments, the base 428 may not be substantially flat and may be curved or at an angle going from a perimeter 470 of the edge formation 422 to the sixth side 418. In additional embodiments, the base 428 may be offset from the sixth side 418 or different bases 428 of different edge formations 422 may be offset from one another.

While the embodiments of FIGS. 9-12 each illustrate a certain number of edge formations 422 formed in the end cap 400, other embodiments of the end cap 400 may include a different number of edge formations 422. Additionally, the shape of the edge formations 422 may be a different shape, such as a triangular, rectangular, another polygonal shape, or any combination thereof. The configuration of the edge formations 422 may also differ from one edge formation 422 to another. As an example, the edge formations 422 of the first side 402 may include a different shape, quantity, or angle of the vertex line 434 than the edge formations 422 of the second side 404. In other embodiments, the respective edge formations 422 of the first side 402 may be different from one another. The different geometries of the edge formations 422 may result in a different profile 450. In some embodiments, the profile 450 may generate an outline similar to the profile 300 of FIG. 8, including edge formations 422 of different geometries, departure angles, approach angles, crests, troughs, etc. The different configurations of the edge formations 422 may depend on aforementioned factors of the fan blade and may also depend on the balance of the fan blade.

In some embodiments, the end cap 400 may be a different shape that is depicted by FIGS. 9-12, which illustrates the end cap 400 as including a generally rectangular shape. For example, any of the sides of the end cap 400 may be curved or angled rather than straight, as generally illustrated in FIGS. 9-12. Moreover, the slit 406 may also include a geometry that is curved, such as to better fit onto a fan blade. In this manner, the geometry of the slit 406 may also change the geometry of the end cap 400, such as to curve the end cap 400. In some embodiments, rather than being a single piece containing both the first side 402 and the second side 404, the end cap may include two separate pieces that cooperatively make up the first side 402 and the second side 404. Therefore, coupling the end cap 400 may include coupling the first side 402 to a surface of the fan blade, such as a pressure surface, then coupling the second side 404 to a different surface of the fan blade, such as a suction surface.

In order for the end cap 400 to be used during operation of the fan, the end cap 400 may be made of a material that may endure rotation of the fan blade without substantially increasing the weight of the fan blade to affect performance. For example, the end cap 400 may be made of carbon fiber, polymer, lightweight metal, another suitable material, or any combination thereof. Additionally, end caps 400 of different materials may be coupled to the same blade, such as at different edges of the blade or along the same edge of the blade. In embodiments where the end caps 400 are of individual pieces separating the first side 402 and the second side 404, the individual pieces may also be of different materials to one another.

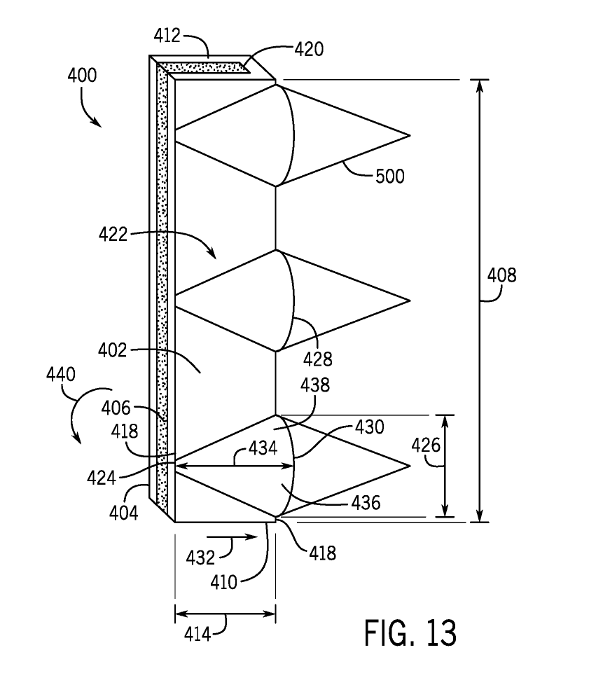

FIG. 13 is a perspective side view of an embodiment of the end cap 400. In the illustrated embodiment, the edge formations 422 include an extended section 500. The extended section 500 extends from the base 428 away from the second side 404. That is, the extended sections 500 may also include the incline surface 436 and the decline surface 438 to form a generally conical shape. As such, when the end cap 400 is coupled to the fan blade 200, the extended sections 500 extend beyond the main portion 116 of the fan blade 200. For example, the extended sections 500 may extend beyond and away from the trailing edge 114 of the fan blade 200 when the end cap 400 is installed on the trailing edge 114. In some embodiments, the extended sections 500 are symmetrical to the sections of the edge formations 422 coupled to the first side 402 of the end cap 400 relative to the base 428. In alternative or additional embodiments, the extended sections 500 are asymmetrical to the sections of the edge formations 422 coupled to the first side 402 relative to the base 428. For example, the incline surfaces 436 and decline surfaces 438 of the extended sections 500 may be formed at respective angles different from the incline surfaces 436 and decline surfaces 438 of the edge formations 422. In some embodiments, a certain number of the extended sections 500 of the end cap 400 are symmetrical while the remaining extended sections 500 of the same end cap 400 are asymmetrical to the sections of the edge formations 422 coupled to the first side 402 relative to the base 428.

As set forth above, the fan blades of the present disclosure may provide one or more technical effects useful in the operation of HVAC systems. For example, the fan blades may include edge formations to create an uneven profile at an edge, such as the leading edge, distal edge, or trailing edge of the fan blade. The uneven profile may disrupt the flow of air across the fan blades during rotation of the fan blades by separating the airflow to redirect the flow in different directions. The disruption of the flow may reduce noise that otherwise would be generated by the movement of air, such as across a smooth profile. The reduction in noise may result in less fan power lost to generating noise, thereby increasing an efficiency of the fan. The edge formations may be formed directly onto the fan blade or may be on a separate piece that may couple to the fan blade. In this manner, the edge formations may be integrally formed with the fan blades or the edge formations may be placed onto fan blades that have already been formed. The edge formations may include different geometries from one another to accommodate the configuration of the fan blade to optimize the reduction of noise. The technical effects and technical problems in the specification are examples and are not limiting. It should be noted that the embodiments described in the specification may have other technical effects and can solve other technical problems.

While only certain features and embodiments of the disclosure have been illustrated and described, many modifications and changes may occur to those skilled in the art, such as variations in sizes, dimensions, structures, shapes and proportions of the various elements, values of parameters, mounting arrangements, use of materials, colors, orientations, and the like, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosed embodiments, or those unrelated to enabling the claimed embodiments. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A fan blade, comprising:
an edge formation disposed on an edge of the fan blade, wherein the edge formation comprises an incline surface relative to a main portion of the fan blade and a decline surface relative to the main portion of the fan blade, and wherein the incline surface and the decline surface are asymmetric to one another.

2. The fan blade of claim 1, wherein the edge formation is integrally formed with the fan blade.

3. The fan blade of claim 1, comprising an end cap having the edge formation, wherein the end cap is coupled to the edge of the fan blade.

4. The fan blade of claim 3, wherein the end cap is coupled to the fan blade via adhesives, fasteners, welds, pressing, or any combination thereof.

5. The fan blade of claim 3, wherein the end cap comprises a suction side, a pressure side, and a slot disposed between the suction side and the pressure side, wherein the edge of the fan blade is disposed within the slot.

6. The fan blade of claim 5, wherein the edge formation is a first edge formation disposed on the suction side, and wherein the end cap comprises a second edge formation disposed on the pressure side.

7. The fan blade of claim 6, wherein the first edge formation and the second edge formation are offset from one another along a length of the end cap.

8. The fan blade of claim 1, wherein the edge formation is generally conical.

9. The fan blade of claim 1, wherein the incline surface comprises a departure angle relative to the main portion of the fan blade, and the decline surface comprises an approach angle relative to the main portion of the fan blade.

10. The fan blade of claim 9, wherein the departure angle is greater than the approach angle.

11. The fan blade of claim 1, wherein the edge of the fan blade comprises a leading edge, a trailing edge, a distal edge, or a combination thereof.

12. An end cap for a fan blade, comprising:
an edge formation disposed on a side of the end cap, wherein the edge formation comprises an incline surface relative to the side of the end cap and a decline surface relative to the side of the end cap, wherein the incline surface and the decline surface are asymmetric relative to one another, and wherein the incline surface and the decline surface form a base of the edge formation.

13. The end cap of claim 12, wherein the end cap is configured to be disposed about a leading edge, trailing edge, or distal edge of the fan blade.

14. The end cap of claim 12, wherein the end cap comprises a suction side, a pressure side, and a slot disposed between the suction side and the pressure side, wherein the slot is configured to receive an edge of the fan blade, wherein the edge formation is a first edge formation disposed on the suction side, and wherein the end cap comprises a second edge formation disposed on the pressure side.

15. The end cap of claim 14, wherein the first edge formation and the second edge formation are offset from one another along a length of the end cap.

16. The end cap of claim 12, wherein the end cap comprises an additional edge formation disposed on the side of the end cap, wherein the additional edge formation comprises an additional incline surface relative to the side of the fan blade and an additional decline surface relative to the side of the fan blade.

17. The end cap of claim 12, wherein the incline surface forms a departure angle relative to the side and wherein the decline surface forms an approach angle relative to the side.

18. The end cap of claim 17, wherein the departure angle is greater than the approach angle.

19. The end cap of claim 12, wherein the end cap is formed from a plastic, a polymer, a metal, a 3-D printed material, or any combination thereof.

20. The end cap of claim 12, wherein the edge formation further comprises an extended section extending from the base.

21. A fan blade, comprising:
a first set of edge formations disposed on a first edge of the fan blade, wherein each edge formation of the first set of edge formations comprises a first incline surface relative to a main portion of the fan blade and a first decline surface relative to the main portion of the fan blade, wherein the first incline surface and the first decline surface are asymmetric to one another; and
a second set of edge formations disposed on a second edge of the fan blade, wherein each edge formation of the second set of edge formations comprises a second incline surface relative to the main portion of the fan blade and a second decline surface relative to the main portion of the fan blade.

22. The fan blade of claim 21, wherein the first edge is opposite the second edge relative to the main portion of the fan blade.

23. The fan blade of claim 21, wherein the first incline surface is a different geometry compared to the second incline surface.

24. The fan blade of claim 21, wherein each edge formation of the first set of edge formations comprises a first width, wherein each edge formation of the second set of edge formations comprises a second width, and wherein the first width is different than the second width.

25. The fan blade of claim 21, wherein each edge formation of the first set of edge formations comprises a first height, wherein each edge formation of the second set of edge formations comprises a second height, and wherein the first height is different than the second height.

26. The fan blade of claim 21, wherein the first set of edge formations comprises a different number of edge formations than the second set of edge formations.
